(19) United States
(12) Patent Application Publication
(10) Pub. No.: US 2022/0335281 A1
(43) Pub. Date: Oct. 20, 2022

(54) DEVICE AND IN PARTICULAR COMPUTER-IMPLEMENTED METHOD FOR VERIFICATION

(71) Applicant: Robert Bosch GmbH, Stuttgart (DE)

(72) Inventors: Thomas Spieker, Stuttgart (DE); Ernst Kloppenburg, Ditzingen (DE); Konrad Groh, Stuttgart (DE)

(21) Appl. No.: 17/658,843

(22) Filed: Apr. 12, 2022

(30) Foreign Application Priority Data
Apr. 19, 2021 (DE) 10 2021 109 751.7

(51) Int. Cl. G06N 3/063; G06N 3/08

(52) U.S. Cl. CPC G06N 3/063; G06N 3/082

(57) ABSTRACT

A device and a method, in particular a computer-implemented method, for the verification of an artificial neural network that is trained to map an input point from an input space of a function, in particular a limited or Lipschitz-constant function, as accurately as possible onto a functional value of the function. A test point is specified, the test point including a pair of a test input point from the input space of the function and a test functional value, the input point being determined from the input space, the input point being mapped by the artificial neural network onto the functional value, a reference for the functional value being determined using the test input point, a deviation of the functional value from the reference being determined, and a measure of a susceptibility to error of the artificial neural network being determined as a function of the deviation.

### CROSS REFERENCE

The present application claims the benefit under 35 U.S.C. § 119 of German Patent Application No. DE 10 2021 109 751.7 filed on Apr. 19, 2021, which is expressly incorporated herein by reference in its entirety.

### BACKGROUND INFORMATION

Artificial neural networks can be used as models for the approximation of functions that describe physical and/or chemical relations in machines. However, the use of such models in safety-critical applications is limited, because it is not completely predictable how reliable an output of the artificial neural network is.

### SUMMARY

Through the method, the device, and the computer program in accordance with the present invention, the artificial neural network is statistically evaluated within the input space.

In accordance with an example embodiment of the present invention, the computer-implemented method for the verification of an artificial neural network that is trained to map an input point from an input space of a function, in particular, a limited or Lipschitz-constant function, as accurately as possible onto a functional value of the function provides that a test point is specified, the test point including a pair of a test input point from the input space of the function and a test functional value, the input point being determined from the input space, the input point being mapped by the artificial neural network onto the functional value, a reference for the functional value being determined using the test point, a deviation of the functional value from the reference being determined, and a measure of a susceptibility to error of the artificial neural network being determined as a function of the deviation. The test point is a known, in particular measured, data point. The input point is a data point that is subjected to a test. The reference is a boundary between a result that is desired or that can be expected and a result that is not desired or is not to be expected. The measure makes a statistically robust statement about the reliability of the artificial neural network. The measure indicates a susceptibility to error of a machine in which the artificial neural network is used for the approximation of the function.

In accordance with an example embodiment of the present invention, in order to improve operational safety of the machine, it can be provided that the function describes a curve of an in particular physical or chemical variable in the machine, changes in the variable in the curve being limited by in particular physical and/or chemical properties of the machine and/or by in particular physical and/or chemical properties of components of the machine, the machine or the component being controlled as a function of the functional value if the measure of the susceptibility to error is smaller than a threshold value, and the machine or the component otherwise not being controlled as a function of the functional value.

In order to increase the operational safety of the machine, it can be provided that the function describes a curve of an in particular physical or chemical variable in a machine, changes of the variable in the curve being limited by in particular physical and/or chemical properties of the machine and/or by in particular physical and/or chemical properties of components of the machine, the artificial neural network being transferred into a machine when the measure of the susceptibility to error is smaller than a threshold value, or otherwise the artificial neural network not being transferred.

Preferably, as a function of the test input point or relative thereto, in particular in a neighborhood of the test input point, input points are determined from the input space, a probability being determined that among these input points there is an input point that is mapped by the artificial neural network onto a functional value whose deviation does not fulfill the condition, the deviation fulfilling the condition either when it is determined that the deviation is smaller than a threshold value or when it is determined that the deviation is greater than a threshold value or when it is determined that the deviation is within an upper and lower bound. In this way, the input points from the input space are subjected to a statistical test.

Preferably, the input points are drawn from the input space in the neighborhood in particular according to a probability distribution, in particular randomly, and/or are drawn so as to be uniformly distributed over the neighborhood. In this way, the informative value of the statistical test is improved.

In accordance with an example embodiment of the present invention, it can be provided that in the input space a distribution, which includes the test input point, of test input points is determined from various test points that divides the input space into regions, in particular either in particular adjacent simplexes or in particular adjacent spheres, the regions each including at least one test input point, a pair being provided per test point of a test input point from the input space of the function and a test functional value of the function, the input point being determined in one of the regions, the reference being determined using the test input point from at least one test point that is included in the region in which the input point is determined, and the measure being determined for the region. In this way, the artificial neural network is verified in the region if the deviation fulfills the condition. Otherwise, the artificial neural network is not verified at least in the region.

Preferably, the simplexes include one of the test input points per vertex of a simplex. Preferably, the spheres each include one of the test input points in their center point. In this way, a statistical coverage is achieved that is as good as possible of a hull of the test points that is as convex overall as possible.

It can be provided that a multiplicity of input points is determined from the input space that lie in one of the regions in the input space, the method including, per input point from the multiplicity of input points, a mapping of the input point by the artificial neural network onto a functional value, and a determination of a deviation of the functional value from the reference, and the measure being determined as a function of the deviations determined in this way for the multiplicity of input points. In this way, the artificial neural network is quantitatively evaluated on the entire measured input space. Here, the evaluation takes place via the probability that, at a point in the given input space, the network will reach a result that deviates strongly from the true functional value.

It can be provided that a multiplicity of input points is determined from the input space that lie in different regions in the input space, the method including, per region of the various regions, a mapping of an input point from this region by the artificial neural network onto a functional value, a determination of a reference for this functional value, using the test input point, from at least one test point that this region includes, a determining of a deviation of this functional value from this reference, and the measure being determined as a function of a frequency with which the thus determined deviations fulfill the condition for their respective region. The frequency quantifies a probability that an input point from the input space is mapped onto a functional value that lies in a desired value range. In this way, the susceptibility to error can be estimated particularly well.

It can be provided that the reference is determined as a function of a difference between the input point and the test input point, the difference being weighted with a Lipschitz constant L of the function.

In accordance with an example embodiment of the present invention, the device for the verification of an artificial neural network that is trained to map an input point from an input space of a function, in particular a limited or Lipschitz-constant function, as accurately as possible onto a functional value of the function is designed to carry out the method. A computer program is also provided that includes computer-readable instructions upon whose execution by a computer the method is run.

Further advantageous specific embodiments result from the following description and the figures.

### BRIEF DESCRIPTION OF THE DRAWINGS

FIG. 1 shows a schematic representation of a part of a device for the verification of an artificial neural network, in accordance with an example embodiment of the present invention.

FIG. 2 shows steps in a method for verification, in accordance with an example embodiment of the present invention.

FIG. 3 shows a schematic representation of an input space of a function, in accordance with an example embodiment of the present invention.

FIG. 4 shows a schematic representation of a range for functional values of the function, in accordance with an example embodiment of the present invention.

### DETAILED DESCRIPTION OF EXAMPLE EMBODIMENTS

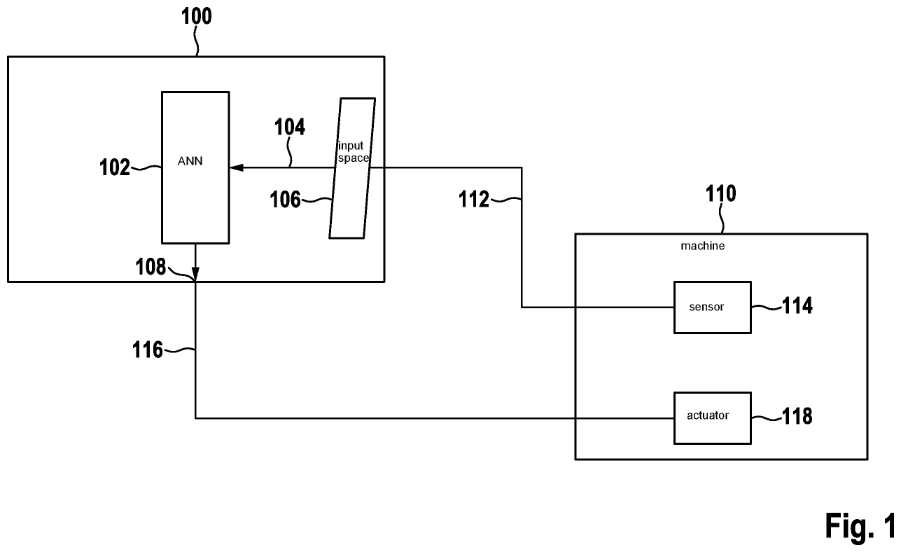

FIG. 1 schematically shows a device 100 for the verification of an artificial neural network 102.

Device 100 includes at least one processor and at least one memory that are designed to carry out a computer program. The computer program includes computer-readable instructions upon whose execution by a computer a method is carried out that is described below.

Artificial neural network 102 is trained to map an input point 104 from an input space 106 of a function, in particular a limited or Lipschitz-constant function, as accurately as possible onto a functional value 108 of the function. Input point 104 and/or functional value 108 can be multidimensional variables. The function does not necessarily have to be Lipschitz-constant. In the following description, a function is assumed that is limited, so that for each input point 104 that is determined, in particular drawn, from input space 106, an upper and/or lower bound is capable of being determined. The Lipschitz-constant function is a special case of the limited function.

In general, a function is used that indicates the upper and lower bound. In the example, this function is constructed such that it includes assumptions and/or prior knowledge about a technical system to be modeled with the function. As an example, a k-nearest neighbor function or a linear interpolation is constructed that indicates an exact value for the input points of the function.

It can also be provided that the function is defined by a finite element method model that outputs exact values at input points. The upper and/or lower bound is defined for example by a tolerable offset to the exact value. This offset is for example additively or multiplicatively added to the value and/or subtracted from the value.

In the example, the function describes a curve of an in particular physical or chemical variable in a machine 110. In the example, changes in the variable in the curve are limited by in particular physical and/or chemical properties of machine 110 and/or by in particular physical and/or chemical properties of components of machine 110.

A possible example of use for machine 110 is an engine control unit. When there is a measurement of fuel injection times over a pressure curve in the engine, the pressure curve is limited by the physical conditions in the engine, which also limit the permissible predictions of artificial neural network 102. Therefore, a statistical assessment of the prediction of neural network 102 is possible.

In the example, device 100 is designed to determine a measure of a susceptibility to error of artificial neural network 102. In the example, artificial neural network 102 is provided for the approximation of the function. As a function of the measure, it is for example possible either to perform an approximation with artificial neural network 102 in order to determine functional value 108 for input point 104, or not. In safety-critical products, this measure can be used to increase operational safety. In the example, the measure quantifies a quality of artificial neural network 102 on the entire input space, or in a region of the input space.

Machine 110 can for example perform tasks from the area of autonomous driving or driver assistance systems.

Device 100 can be designed to control or to regulate machine 110.

Device 100 is for example designed to acquire a signal 112 at machine 110 or at a component of machine 110, using a sensor 114. In the example, device 100 is designed to determine input point 104, i.e. an actual input point, as a function of signal 114. Input point 104 can also be determined from the signal by a computing operation. Input point 104 can also be determined as a function of signals that are acquired by a plurality of sensors. In the example, machine 110, or the component thereof, is designed to be controlled using functional value 108. For example, device 100 is designed to output a target value 116 for an actuator 118 as a function of functional value 108, i.e. of a target functional value. Device 100 can be designed to determine a multiplicity of target values for various actuators as a function of functional value 108.

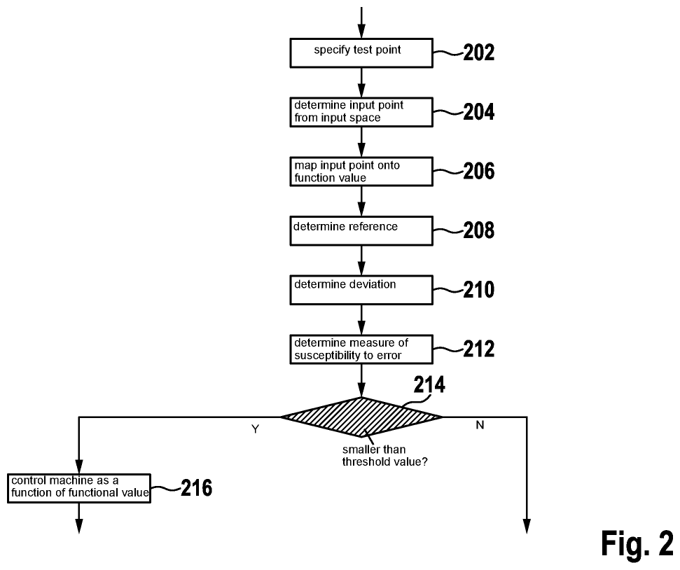

In FIG. 2, steps are shown of the in particular computer-implemented method for the verification of artificial neural network 102.

Artificial neural network 102 is trained to map input point 104 at a location from input space 106 as accurately as possible onto the functional value 108 that the function has at the location.

In the example, artificial neural network 102 is trained using training points. In the example, per training point a pair is provided of a training input point at a location from input space 106 of the function and a training functional value of the function at this location. The pairs are for example measured. The method itself can include the acquiring of the training points. The training points can also be acquired before the method is carried out. The method itself can include the training before the steps described below are carried out.

In a step 202, at least one test point is specified. The at least one test point includes a pair of a test input point from input space 106 of the function and a test functional value of the function. In the example, per test point a pair is provided of a test input point at a location from input space 106 of the function and a test functional value of the function at this location. The pairs are for example measured. The method itself can include the acquiring of the test points. The test points can also be acquired before the method is carried out.

It can be provided that in the input space a distribution, including the test input point, of test input points is determined from various test points, which distribution divides the input space into regions.

In the example, the regions each include at least one test input point.

In an example, the regions are in particular simplexes that adjoin one another. The simplexes include for example one of the test input points per vertex of a simplex.

In an example, the regions are in particular adjoining spheres. The spheres include for example one of the test input points in each of their centers.

Subsequently, a step 204 is carried out.

In step 204, as a function of the test input point, or relative thereto, an input point from input space 106 is determined. Preferably, the input point is determined in a neighborhood of the test input point. The neighborhood is determined as a function of the test input point for example via a distance measure relative to the test input point. In the example, the test input point is drawn from input space 106 in the neighborhood in particular according to a probability distribution, in particular randomly. It can be provided that the input point is interpolated between two or more test input points. In the example, the input points are interpolated between the test input points. Preferably, input points are determined from input space 106 in the neighborhood of the test input point via the distance measure to the test input point.

Subsequently, a step 206 is carried out.

In step 206, the input point is mapped by the artificial neural network onto the functional value.

Subsequently, a step 208 is carried out.

In step 208, with the test input point a reference is determined for the functional value.

The reference is for example determined using the test input point from at least one test point that is included in the region in which the input point is determined.

In the example, the reference is determined as a function of a difference between the input point and the test input point, the difference being weighted with a Lipschitz constant L of the function.

Subsequently, a step 210 is carried out.

In step 210, a deviation of the functional value from the reference is determined.

In an example, the steps 204 through 210 are carried out for a plurality of input points from the input space.

In an example, a multiplicity of input points are drawn in a manner uniformly distributed over the input space.

In an example, a multiplicity of input points are determined from the input space that lie in one of the regions in the input space. It can be provided that these are drawn from the region randomly and/or in uniformly distributed fashion.

In an example, a multiplicity of input points from the input space is determined that lie in different regions in the input space. It can be determined that these are drawn from the respective region randomly and/or in uniformly distributed fashion.

For example, per region a reference is determined using the test input point from at least one test point that is included in this region. For example, per region a mapping by artificial neural network 102 of an input point from this region onto a functional value is provided, a determining is provided of a reference for this functional value using the test input point from at least one test point that this region includes, and a determining is provided of a deviation of this functional value from this reference.

Subsequently, a step 212 is carried out.

In step 212, the measure for the susceptibility to error of artificial neural network 102 is determined as a function of the deviation.

In the example, the measure is determined as a function of the deviations determined for the multiplicity of input points.

It can be provided that the measure is determined for the regions. This measure indicates the susceptibility to error of artificial neural network 102 in the entire input space.

It can be provided that the measure is determined for a single region. This measure indicates the susceptibility to error of artificial neural network 102 in a part of the input space limited by the region.

It can be provided that the measure is determined individually for different regions. This measure indicates the susceptibility to error of artificial neural network 102 in the part of the input space limited by these regions.

The measure is for example determined as a function of a frequency with which the thus determined deviations fulfill the condition for their respective region.

In an example, a probability is determined that among the input points for which the measure is determined there is an input point that is mapped by artificial neural network 102 onto a functional value whose deviation does not fulfill a condition. In the example, the probability is determined as a function of the frequency.

The deviation fulfills the condition for example if it is determined that the deviation is smaller than a threshold value.

The deviation fulfills the condition for example if it is determined that the deviation is greater than a threshold value.

The deviation fulfills the condition for example if it is determined that the deviation is within an upper and lower bound.

The measure provides a quantitative statement about a predictive power of artificial neural network 102. In the following, this is described for simplexes.

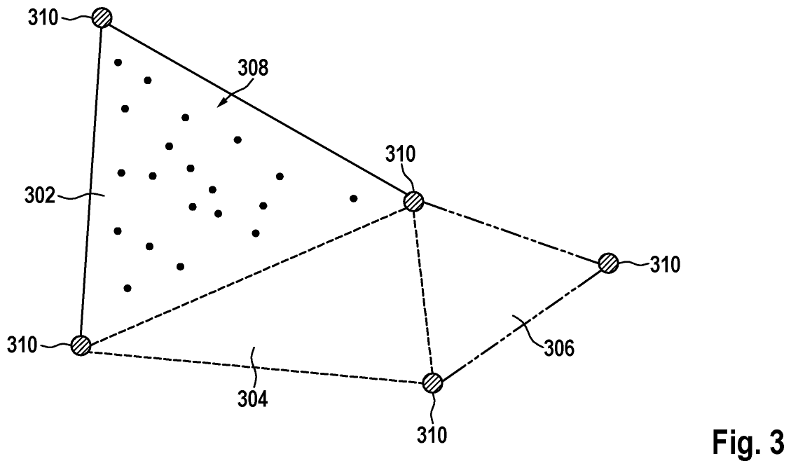

Using the test points, the input space is divided into simplexes that are spanned by the test points. An example of this is shown schematically in FIG. 3 for a first simplex 302, a second simplex 304, and a third simplex 306. In first simplex 302, drawn input points 308 are schematically shown as points. The vertices of the simplexes are formed by test points 310. Test points 310 are data points that were measured for example in a system, for example machine 110.

Under the assumption that an actual system response between measured data points in reality does not make strong jumps, a maximum deviation of the functional values is limited by the functional values at the vertices of a simplex.

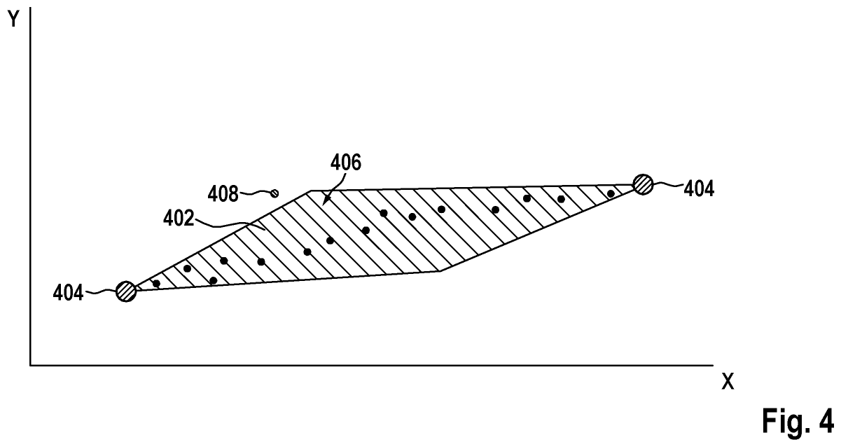

This is shown schematically in FIG. 4 for region 402 that extends between two test points 404. In region 402 there are situated functional values 406 onto which input points are mapped by artificial neural network 102. These are schematically shown in FIG. 4 as points. The measure of the susceptibility to error in this case indicates how probable it is that an input point is mapped onto a functional value that lies outside region 402. In FIG. 4, a point 408 represents, as an example, a functional value that lies outside region 402.

The scope of region 402 represents the upper and lower bound for the prediction of functional values by artificial neural network 102. Instead of a region 402, an upper and lower bound, or a threshold value, e.g. for a distance between a respective input point and one of the test points 404, can be provided weighted with Lipschitz constant L.

Using the method, it is checked whether a predicting activity of artificial neural network 102 provides false predictions for randomly drawn input points.

f:X→Yg:X→Y(xᵢ,yᵢ) ∈ (X,Y)i ∈ {0, . . . , n}∀i ∈ {0, . . . , n}|f(xᵢ)=g(xᵢ)=yᵢp(λᵢⱼ)=λᵢⱼxⱼ+(1−λᵢⱼ)xᵢ with λᵢⱼ ∈ [0,1]

In the example, is artificial neural network 102, which approximates a physical process. In the following, g designates a ground truth behavior of the process to be modeled, and with designates n test points for which the performance of artificial neural network 102 is determined. Artificial neural network 102 is trained in such a way that the following holds as precisely as possible: . In the example, the physical process g is Lipschitz-constant, with Lipschitz constant L, so that the true functional value is always limited between two arbitrary test data points. In the following, this is described for a one-dimensional simplex spanned by two test points:

f:X→Yg:X→Y(xᵢ,yᵢ) ∈ (X,Y)i ∈ {0, . . . , n}∀i ∈ {0, . . . , n}|f(xᵢ)=g(xᵢ)=yᵢp(λᵢⱼ)=λᵢⱼxⱼ+(1−λᵢⱼ)xᵢ with λᵢⱼ ∈ [0,1]

For this, the following holds:

∀λᵢⱼ ∈ [0,1]∥g(p(λᵢⱼ))−g(xᵢ)|<cᵢⱼ=L|p(λᵢⱼ)−xᵢ|

This means that the true functional value of g(xₛ) is known for all points within the simplex xₛ.

For test points measured very densely in the input space, it can be provided that a local linearity of the input space is assumed. In this case,

g(p(λᵢⱼ))=λᵢⱼyⱼ+(1−λᵢⱼ)yᵢ

is assumed as known, where yⱼ=g(xⱼ) and yᵢ=g(xᵢ).

A null hypothesis H0 for this is that artificial neural network 102 predicts all functional values inside region 402:

H0:∀x ∈ X′∥f(x)−g(xᵢ)|<cₒᵢ or pₒ=0

H1:∃S ⊂ X′∥f(xₒ)−g(xᵢ)|>cₒᵢ ∀ xₒ ∈ S or pₒ>0

where X′ ⊂ X is the input space spanned by the simplex, xᵢ is a vertex of the simplex, and pₒ is a probability that is to be investigated.

(nₒ=0|H1′)=B(nₒ=0|pₒ,N)=(1−pₒ)^{N}<α

For the application, a complement H1 of the null hypothesis H0 is limited to the subset S of a determined proportional variable of X′. With the hypothesis H1′ limited in this way, for the probability for example the following binomial distribution B of the functional values is expected:

(nₒ=0|H1′)=B(nₒ=0|pₒ,N)=(1−pₒ)^{N}<α

where nₒ=0 occurs when the randomly drawn points do not include any whose predicted functional value lies outside region 402, where N is a number of randomly drawn input points in the simplex and α is a prespecified significance level.

The probability decreases as the number N of tested input points increases. For a given significance level α, the number N can be increased until this significance level α is reached.

Alternatively, given a fixed number N the probability pₒ can be reduced until the significance level α is reached. In this way, the smallest probability pₒ is found that can be excluded for the number N of random numbers with significance level pₒ.

In the example, this procedure is carried out individually for adjacent simplexes. In this way, a statistical coverage of an entire convex hull of the test points is achieved. In this way, the entire measured input space can be verified.

The statistical tests in the various simplexes can be finally combined in an overall number, the measure of the susceptibility to error.

In an example, the measure is determined as a maximum ascertained probability for a fixed number N. This represents a conservative choice.

In an example, the measure is determined for the result of a single simplex. For example, a plurality of measures are determined for various simplexes. In this way, an evaluation is carried out in different regions of the input space.

Through the measure, the null hypothesis H0 is verified in that the complement H1 is asymptotically falsified. Each nₒ≠0 or nₒ>0 results in a falsification of the null hypothesis H0. In this case, the measure indicates the susceptibility of error through an actual probability of failure.

This makes it possible to decide in a quantified manner whether such a probability of failure is acceptable or not.

Optionally, after step 212 a step 214 is carried out.

In step 214, it is checked whether the measure of the susceptibility to error is smaller than a threshold value. If the measure of the susceptibility to error is smaller than the threshold value, then a step 216 is carried out.

In step 216, the machine 110 or the component is controlled as a function of functional value 108.

Otherwise, machine 110 or the component is not controlled as a function of the functional value. In this case, it can be provided to continue the method at step 204.

Step 216 can also provide that artificial neural network 102 is transferred into machine 110 if the measure of susceptibility to error is smaller than the threshold value. Otherwise, artificial neural network 102 is not transferred into the machine.

What is claimed is:

1. A computer-implemented method for verifying an artificial neural network that is trained to map an input point from an input space of a function as accurately as possible onto a functional value of the function, the function being a limited or Lipschitz-constant function, the method comprising:
specifying a test point, the test point including a pair of a test input point from the input space of the function and a test functional value, the input point being determined from the input space;
mapping the input point by the artificial neural network onto the functional value;
determining a reference for the functional value using the test input point;
determining a deviation of the functional value from the reference; and
determining a measure of a susceptibility to error of the artificial neural network as a function of the deviation.

2. The method as recited in claim 1, wherein the function describes a curve of a physical or chemical variable in a machine, changes of the variable in the curve being limited by: (i) physical and/or chemical properties of the machine, and/or (ii) physical and/or chemical properties of components of the machine, wherein the machine or the component is controlled as a function of the functional value when the measure of the susceptibility to error is smaller than a threshold value, and otherwise the machine or the component not being controlled as a function of the functional value.

3. The method as recited in claim 1, wherein the function describes a curve of a physical or chemical variable in a machine, changes of the variable in the curve being limited by: (i) physical and/or chemical properties of the machine, and/or by in particular physical, and/or (ii) chemical properties of components of the machine, wherein the artificial neural network is transferred into a machine when the measure of the susceptibility to error is smaller than a threshold value, and otherwise the artificial neural network not being transferred.

4. The method as recited in claim 1, wherein, as a function of the test input point or in a neighborhood of the test input point, input points are determined from the input space, a probability being determined that among the input points there is an input point that is mapped by the artificial neural network onto a functional value whose deviation does not fulfill a condition, the deviation fulfilling the condition either when it is determined that the deviation is smaller than a threshold value or when it is determined that the deviation is greater than a threshold value or when it is determined that the deviation is within an upper and lower bound.

5. The method as recited in claim 4, wherein the input points are drawn from the input space in the neighborhood according to a probability distribution randomly, and/or are drawn in a manner uniformly distributed over the neighborhood.

6. The method as recited in claim 1, wherein in the input space a distribution that includes the test input point is determined of test input points from various test points that divides the input space into regions, the regions being adjacent simplexes or adjacent spheres, the regions each including at least one test input point, a pair being provided per test point of a test input point from the input space of the function and a test functional value of the function, the input point being determined in one of the regions, the reference being determined, using the test input point, from at least one test point that is included in the region in which the input point is determined, and the measure being determined for the region.

7. The method as recited in claim 6, wherein the simplexes include one of the test input points per vertex of a simplex, or the spheres each include one of the test input points in their center.

8. The method as recited in claim 6, wherein a multiplicity of input points are determined from the input space, the multiplicity of input points lying in one of the regions in the input space, the method including, for each respective input point from the multiplicity of input points, mapping the respective input point by the artificial neural network onto a respective functional value and determining of a deviation of the respective functional value from the reference, and the measure being determined as a function of the deviations thus determined for the multiplicity of input points.

9. The method as recited in claim 6, wherein a multiplicity of input points from the input space are determined that lie in various regions in the input space, the method including, for each region of the various regions, mapping an input point of the multiplicity of input points from this region by the artificial neural network onto a respective functional value, determining a reference for the functional value, using the test input point, from at least one test point that is included in the region, and determining a deviation of the respective functional value from the reference, and wherein the measure is determined as a function of a frequency with which the determined deviations fulfill a condition for their respective region.

10. The method as recited in claim 1, wherein the reference is determined as a function of a difference between the input point and the test input point, the difference being weighted with a Lipschitz constant of the function.

11. A device configured to verify an artificial neural network that is trained to map an input point from an input space of a function as accurately as possible onto a functional value of the function, the function being a limited or Lipschitz-constant function, the device being configured to:
specify a test point, the test point including a pair of a test input point from the input space of the function and a test functional value, the input point being determined from the input space;
map the input point by the artificial neural network onto the functional value;
determine a reference for the functional value using the test input point;
determine a deviation of the functional value from the reference; and
determine a measure of a susceptibility to error of the artificial neural network as a function of the deviation.

12. A non-transitory computer-readable medium on which is stored a computer program including computer-readable instructions for verifying an artificial neural network that is trained to map an input point from an input space of a function as accurately as possible onto a functional value of the function, the function being a limited or Lipschitz-constant function, the instructions, when executed by a computer, causing the computer to perform the following steps:
specifying a test point, the test point including a pair of a test input point from the input space of the function and a test functional value, the input point being determined from the input space;
mapping the input point by the artificial neural network onto the functional value;
determining a reference for the functional value using the test input point;
determining a deviation of the functional value from the reference; and
determining a measure of a susceptibility to error of the artificial neural network as a function of the deviation.
